(19) United States
(12) Patent Application Publication
(10) Pub. No.: US 2024/0070701 A1
(43) Pub. Date: Feb. 29, 2024

(54) SYSTEMS AND METHODS TO IDENTIFY EXPRESSIONS FOR OFFERS TO BE PRESENTED TO USERS

(71) Applicant: Solsten, Inc., St. Paul, MN (US)

(72) Inventor: Joseph Jack Schaeppi, Maple Grove, MN (US)

(21) Appl. No.: 17/896,965

(22) Filed: Aug. 26, 2022

(51) Int. Cl. G06Q 30/02

(52) U.S. Cl. CPC G06Q 30/0209; G06Q 30/0201

(57) ABSTRACT

Systems and methods to identify expressions for offers to be presented to users are disclosed. Exemplary implementations may: receive, from an online platform, a user action that the online platform intends users of the online platform to complete; determine, based on psychological profiles, one or more expressions to be utilized to motivate the users associated with the psychological profiles to complete the user action; generate, based on the one or more determined expressions and the user action, offers for the users; and present, via digital environments provided by the online platforms, the offers to the user.

### FIELD OF THE DISCLOSURE

The present disclosure relates to systems and methods to identify expressions for offers to be presented to users.

### BACKGROUND

Users typically use a plurality of online platforms via smart devices and thus interact with a plurality of various content provided by those online platforms in digital environments. When the online platforms promote or release content, the online platforms may typically offer the same content to all the users in a generic manner. Given the plurality of users, all of the users may not have affinities and dislikes to the same content as other users. Thus, the offers by the online platforms of the content may be too general and not relate to all the users. Furthermore, the online platforms may fail to provide transparency on the information that they use about the users.

### SUMMARY

One aspect of the present disclosure relates to a system configured to identify expressions for offers to be presented to users. The offers may be based on the psychological profiles of the users, how the users have previously interacted with other content, and/or other information. The offers may include the same content while presenting or promoting the content differently for each of the users. Furthermore, the users may be enabled to specify which information related to themselves they permit the system to utilize to generate these offers. Thus, the system tailors multiple online platforms for multiple users of each of those online platforms to facilitate user engagement with the online platforms. The system may include one or more hardware processors configured by machine-readable instructions. The Machine-readable instructions may include one or more instruction components. The instruction components may include computer program components. The instruction components may include one or more of user action component, expression determination component, offer generating component, presentation component, and/or other instruction components.

The user action component may be configured to receive, from an online platform, a user action that the online platform intends users of the online platform to complete.

The expression determination component may be configured to determine, based on psychological profiles and/or other information, one or more expressions to be utilized to motivate the users associated with the psychological profiles to complete the user action. The psychological profiles for the users and the expressions may be stored in electronic storage. The psychological profiles may include psychological parameter values to psychological parameters. The expressions may be correlated with one or more psychological parameter values to psychological parameters. The expressions may be units of content that prompt and/or encourage users to complete a specific user action.

The offer generating component may be configured to generate, based on the one or more determined expressions and the user action, offers for the users.

The presentation component may be configured to present, via digital environments provided by the online platforms, the offers to the user.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to identify expressions for offers to be presented to users, in accordance with one or more implementations.

FIG. 2 illustrates a method to identify expressions for offers to be presented to users, in accordance with one or more implementations.

FIG. 3A-B illustrates an example implementation of the system configured to identify expressions for offers to be presented to users, in accordance with one or more implementations.

### DETAILED DESCRIPTION

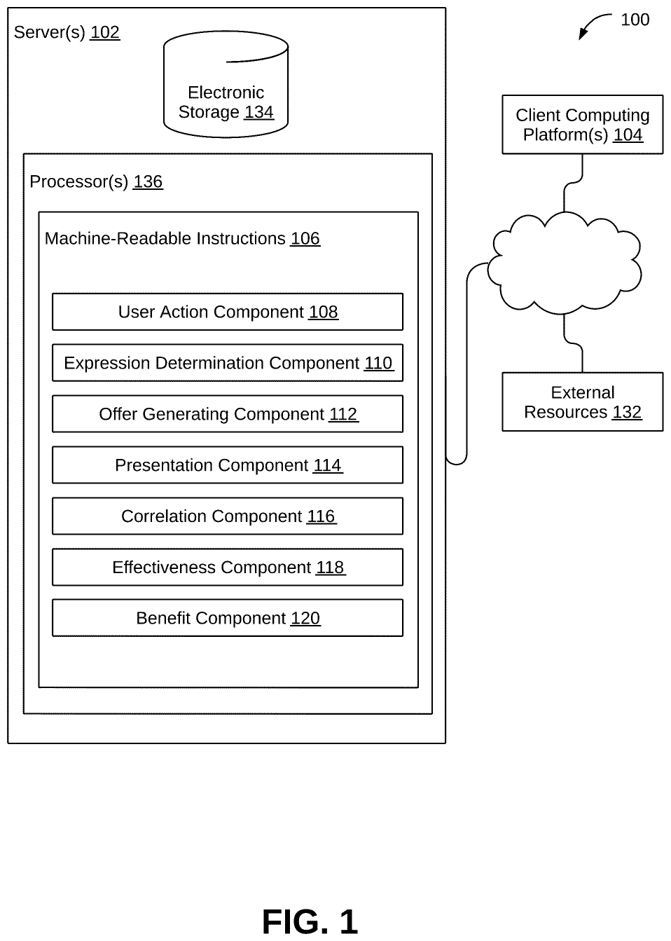

FIG. 1 illustrates a system 100 configured to identify expressions for offers to be presented to users, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of user action component 108, expression determination component 110, offer generating component 112, presentation component 114, correlation component 116, effectiveness component 118, benefit component 120, and/or other instruction components.

Electronic storage 134 may be configured to store psychological profiles for the users, expressions, and/or other information. In some implementations, a given psychological profile may characterize and be for a single unique user. In some implementations, the given psychological profile may characterize and be for more than one user. The psychological profiles may include psychological parameter values to psychological parameters. The psychological profiles may include psychological parameter values for psychological parameters. The psychological profiles may include sets of psychological parameter values to the psychological parameters for the individual users. By way of non-limiting example, the psychological parameter values of the psychological parameters may be a number score on a predetermined range unique to each psychological parameter, a letter score, and/or other type of value than may characterize a particular user as whole.

Parameters, such as psychological parameters are described herein, may specify measurable, recordable, and/or determined information. The parameter values corresponding to the parameters may be a particular value, numerical or non-numerical, that characterizes the content, the users, or respective element that the parameter value is described in relation to.

The psychological parameter values may characterize, by way of non-limiting example, achievement motivation, motivation, personality inventory, cultural values, competitiveness, positive and negative affect before, during, and/or after engagement with the digital experience (i.e., emotions), communication style, personal values, daily routines/activities, life/gaming pain points, life/gaming hopes and aspirations, wellbeing, user experience, gaming/experience using time, subscription behavior, affinity information, personality, emotional style, goal orientation, goal commitment, ego and task orientation, relatedness, sense of community, social influence, social identity, group identification, we-identity, quality of life, satisfaction with life, work-related quality of life, mindfulness, happiness, emotional intelligence, self-awareness/internal awareness, external awareness, connectedness to nature, social connectedness, social bonding, perceived stress, depression, anxiety, decision-making style, thinking style, critical thinking, cognitive approach to learning, learning style, attributional style, internality-externality, stability-instability, global-specific, creativity, curiosity, playfulness, exploration, mental strength, grit, flourishing, gratitude, inspiration, spirituality, hedonism, materialism/material values, perceptions, sentiments, and/or other psychological parameters.

Achievement motivation may include compensatory effort, competitiveness, confidence in success, dominance, eagerness to learn, engagement, fearlessness, flexibility, flow, goal setting, independence, internality, persistence, preference in difficult tasks, pride in productivity, self-control, status orientation, ambition, self-assurance, and/or other psychological parameters. Motivation may include mastery, purpose, autonomy, and/or other psychological parameters.

Personality inventory may include neuroticism, openness, conscientiousness, extraversion, and agreeableness and/or other psychological parameters. Neuroticism may include anxiety, impulsiveness, vulnerability, and/or other psychological parameters. Openness may include fantasy, feelings/empathy, action, and/or other psychological parameters. Conscientiousness may include achievement striving, competence, self-discipline, and/or other psychological parameters. Extraversion may include warmth assertiveness, activity, and/or other psychological parameters. Agreeableness may include trust, altruism, modesty, and/or other psychological parameters.

Cultural values may include individualism, indulgence, long term orientation, masculinity, power distance, uncertainty avoidance, and/or other psychological parameters. Competitiveness may include avoidant, collaborative, competitive affectivity, dependent, dominant, general competitiveness, independent, personal enhancement, and/or other psychological parameters.

Positive and negative affect before, during, and/or after engaging in the digital experience may include hostility, joviality, negative emotions, positive emotions, sadness, self-assurance, and/or other psychological parameters. Communication style may include feeler, intuitor, sensor, thinker, and/or other psychological parameters.

Wellbeing may include social wellbeing, psychological wellbeing, physical wellbeing, physical activity, sleep, bounded reciprocity, resilience grit, and/or other psychological parameters.

Personality may include anger, hostility, depression, self-conscientiousness, excitement-seeking, positive emotions, gregariousness, ideas, values, aesthetics, tender-mindedness, straightforwardness, compliance, deliberation, order, dutifulness, and/or other psychological parameters.

Emotional style may include resilience, outlook, social intuition, self-awareness, sensitivity to context, attention, and/or other psychological parameters.

Goal orientation may include mastery approach/learning goal orientation, performance approach/performance goal orientation, performance avoid/avoidance goal orientation, and/or other psychological parameters.

Work-related quality of life may include structure, boundaries, focus, efficiency, information provision, communication, psychological support, stress at/from work, psychological safety, connectedness with team, motivation to work, adaptability, job/career satisfaction, control at work, home-work interface, general wellbeing, working conditions, and/or other psychological parameters.

Mindfulness may include observing, describing, acting with awareness, non-judgment, non-reactivity, and/or other psychological parameters.

Emotional intelligence may include emotion perception, emotion expression, emotion management, emotion regulation, impulse control, relationships, stress management, and/or other psychological parameters.

Social connectedness may include social connectedness, loneliness, membership self-esteem, private self-esteem, public self-esteem, identity self-esteem, interdependent self, independent self, social avoidance, social distress, and/or other psychological parameters.

Decision-making style may include respected, confident, spontaneous, dependent, vigilant, avoidant, brooding, intuitive, anxious, and/or other psychological parameters.

Thinking style may include intuitive, experiential, analytical, rational, and/or other psychological parameters.

Cognitive approaches to learning may include avoidant, participative, competitive, collaborative, dependent, independent, and/or other psychological parameters.

Learning style may include visual (spatial), aural (auditory-musical), verbal (linguistic), physical (kinesthetic), logical (mathematical), social (interpersonal), solitary (intrapersonal), and/or other psychological parameters.

Mental strength may include tenacity, confidence, optimism, adaptability, self-awareness, reliability, responsibility, well-being, and/or other psychological parameters.

Flourishing may include positive emotion, engagement, relationships, meaning, accomplishment, health, loneliness, and/or other psychological parameters.

The expressions may be units of content that prompt and/or encourage users to complete one or more specific user actions. The expressions may include a text, pictural content, video content, audio content, a graphical image file, and/or other expressions. The pictural content may one or more images. The video content may include one or more videos of various durations. The video content and audio content may comprise of one or more particular voices. In some implementations, individual ones of the expressions may be correlated with one or more of the psychological parameter values to the psychological parameters. It will be appreciated that the description herein of “correlations” between psychological parameters and expressions which are positively correlated is not intended to be limiting, and that negative correlations between psychological parameters and expressions are also contemplated, and may be included in the generic “correlations”. The determination of negative correlations may be made in cases where users strongly presenting a psychological parameter avoid a specific expression, and/or where users that do not present the psychological parameter engage with the specific expression relatively more (e.g., in frequency) than users that strongly present the psychological parameter.

The user actions that the users are encouraged and/or prompted to complete may include purchasing an item, selling an item, trading an item, donating, reading written content, watching video content, listening to audio content, creating content, forming an alliance, interfering or preventing other users from forming an alliance, completing one or more tasks, interfering or preventing other users from completing the one or more tasks, playing a particular game, and/or other user actions. In some implementations, the item may be a piece of content within a digital environment.

User action component 108 may be configured to receive one or more of the user actions that an online platform intends users of the online platform to complete. The one or more user actions may be received from the online platform or an administrator of the online platform via a client computing platform 104 associated with the administrator. In some implementations, a user action may be associated with one or more pieces of content that the online platform added to a digital environment or that an administrator of the online platform is encouraging the users of the online platform to interact with in the digital environment or external to the digital environment. The pieces of content may include a character, a game, a game asset, an image, a video, an audio (e.g., a song, an album, an audiobook), literature (e.g., books, journals, cases), and/or other pieces of content. The character may refer to an object (or group of objects) present in a virtual space that corresponds to an individual user (e.g., an avatar) and/or are controlled by the user. The game may include separate game that the online platform hosts or a mini-game within the digital environment. The game asset may include a virtual item, a virtual resource (e.g., weapon, tool), of in-game powers, in-game skills, in-game technologies, and/or other game assets. Individual pieces of content may be of a content type. For example, the content type may refer to a genre, a game type, a theme, and/or other content types. The game types may include a puzzle game, a matching game, a racing game, a strategy game, a role-playing game, a party game, a multiplayer battle game, an action-adventure game, a survival and horror game, a sports simulation game, a shooter game, and/or other game types.

In some implementations, the one or more user actions may be associated with a time period that the one or more user actions are intended to be completed within. The time period may be received by user action component 108 from the online platform or the administrator. In some implementations, more than one of the user actions may be received in a particular order that they are intended to be completed in.

Client computing platforms 104 (e.g., smartphone, laptop, game console) associated with the users may provide access to a plurality of the applications. In some implementations, the application provided by client computing platform 104 may be initially provided by online platforms (e.g., downloaded from the online platforms). In some implementations, an online platform and a digital environment provided thereof may be referred to as the application. As used herein, the terms “integrated application”, “online application”, “application”, and variations thereof may be used interchangeably and refer to digital environments provided by online platforms that the users may interact with online or offline.

The digital environment and/or individual applications may provide simulated spaces or views of a virtual space. Individual simulated spaces may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance executed by the computer components may be synchronous, asynchronous, and/or semi-synchronous.

Expression determination component 110 may be configured to determine one or more of the expressions to be utilized to motivate the users associated with the psychological profiles to complete the one or more user actions. The determination may be based on psychological profiles and/or other information. In some implementations, the one or more expressions determined may be prioritized from most effective to least effective. In some implementations, the prioritization may be determined and updated in an ongoing manner based on the user actions that are completed, a time period that the user actions were completed in, the one or more expressions utilized, and/or other information. In some implementations, the prioritization may be received by expression determination component 110 from the administrator. Determining the one or more expressions may include determining an amount of the expressions to utilize. The amount may be fixed and modifiable by the administrator. The amount may be determined based on the psychological profiles and/or other information. Thus, in some implementations, the determination of the one or more expressions may be based on the prioritization and/or the amount of the expressions to utilize.

In some implementations, the expressions may include a first expression, a second expression, and/or other expressions. For example, the text for the first expression may be different from the text for the second expression. As another example, the pictural content for the first expression may be different from the pictural content for the second expression. As another example, the video content for the first expression may be different from the video content for the second expression.

Offer generating component 112 may be configured to generate offers for the users. The offers may be generated based on the one or more determined expressions, the one or more user actions, and/or other information. In some implementations, the offers may be presented with one or more aesthetic features. The aesthetic features may include one or more of a font, a font size, a font color, a background color, an offer size, animations of the offer (e.g., flashing, noises, a badge notification), and/or other aesthetic features. In some implementations, the aesthetic features may be determined by offer generating component 112 based on the psychological profiles, the one or more user actions, and/or other information.

In some implementations, offer generating component 112 may be configured to receive user preferences for the offers presented to individual ones of the users. The user preferences may include specifications for the offers, permission for utilization of one or more of the psychological parameters for generation of the offers, and/or user preferences. By way of non-limiting example, the specifications may include one or more of a content type, one or more pieces of content, one or more online platforms, a game, a movie, a show, and/or other specifications. In some implementations, similar or related content to be included in the one or more user actions may be determined based on the specifications. For example, content that is similar to the genre or purpose of a movie specified in the specifications may be determined for offers to be generated based on. For example, the specifications may include all online platforms the individual users interact with.

The user preferences may be associated with and received from the individual users via client computing platforms 104. In some implementations, the individual users may specify which or grant permission for psychological parameters and their corresponding psychological parameter values that offer generating component 112 and/or other components described herein may utilized to generate the offers for them. In some implementations, the user preferences may entirely restrict, or grant no permission, utilization of the users' psychological profiles until the users consent to the permission. Offer generating component 112 may be configured to implement the user preferences.

In some implementations, benefit providing component 120 may be configured to provide, based on the user preferences, benefits to the individual users from the online platforms that are permitted to have offers generated for and presented. By way of non-limiting example, the benefits may include one or more of a monetary amount, a cryptocurrency amount (e.g., Bitcoin, Ether), a stake portion of a company that owns the online platforms, credits usable in the digital environments (e.g., tokens), content usable in the digital environments, admission tickets (e.g., to digital events, movies, concerts, conventions), and/or other benefits. Individual ones of the benefits may be determined based on an amount that the online platforms pay or are prepared to provide for permission to generate and present the offers that are based on the psychological profiles of the users. This amount may be received from the individual online platforms.

Presentation component 114 may be configured to present, via digital environments provided by the online platforms, the offers to the users. The offers may be presented in accordance with the aesthetic features determined. In some implementations, presentation component 114 may determine a time at which to present the offers to the individual users. Determination of the time to present may be based on monitoring the user's current in-platform actions, online status, in-game or in-platform rankings (e.g., top of a leaderboard), and/or other information.

In some implementations, correlation component 116 may be configured to analyze suggestions, recommendations, and/or other content presented to the users via the digital environments and reactive actions by the users to the suggestions, recommendations, and/or other content. The recommendations may include a particular selection and/or action that the user is advised to select and/or do. The suggestions may include particular ideas, plans, and/or strategies for the user to consider executing, following, and/or is determined they will enjoy. For example, the reactive actions may accept or deny the suggestions and/or recommendations.

Correlation component 116 may be configured to determine correlations between the one or more expressions and psychological parameter values to psychological parameters based on the reactive actions accepting the suggestions and/or recommendations, the one or more expressions in the suggestions and/or recommendations, the psychological profiles of the users, and/or other information. Correlation component 116 may be configured to store the correlations between the one or more expressions and the psychological parameter values to the psychological parameters. That is, correlation component 116 may determine whether the one or more expressions included in the suggestions, the recommendations, and/or other content caused the user to accept or instigate an interaction, or deny or disregard such. In some implementations, the same reactive action may be required to occur a particular amount of times prior to correlation component 116 determining and storing a correlation. Such amount may be fixed and modifiable by the administrator or other user, or may be fixed. As such, determination the one or more expressions for the offers by expression determination component 110 may be further based on the correlations.

In some implementations, effectiveness component 118 may be configured to monitor effectiveness of the one or more expressions included in the offers presented to the users. The effectiveness may indicate whether the one or more expressions cause the users to begin and/or complete the one or more user actions. The effectiveness may include an amount of time that lapse between presentation of the offer and the user beginning the user action and/or completing the user action, an amount of times that the same one or more expressions included in the offers caused the same user to begin and/or complete the one or more user actions, and/or other information. Effectiveness component 118 may be configured to update the correlations based on the effectiveness.

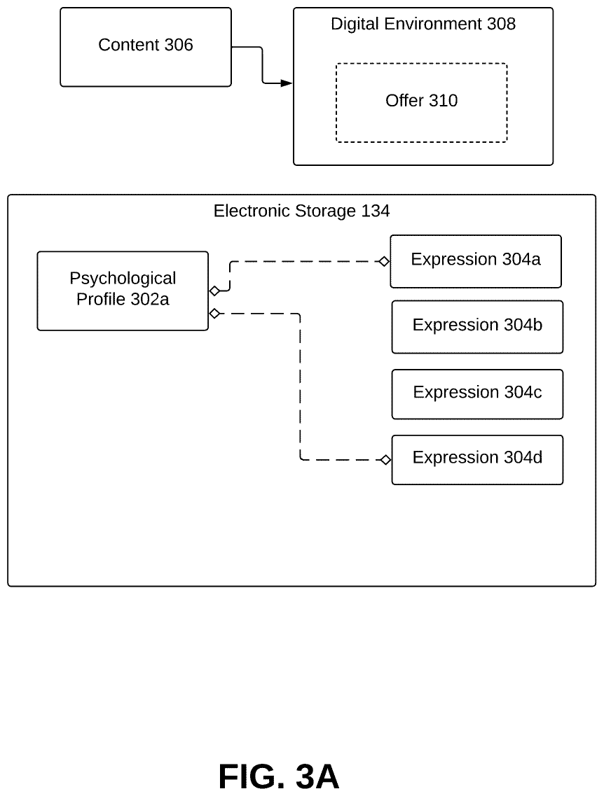

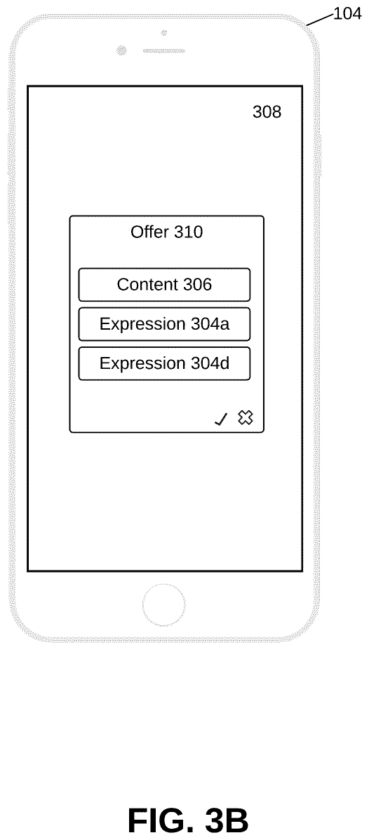

FIG. 3A-B illustrate an example implementation of the system described herein. FIG. 3A illustrates electronic storage 134, similar or the same as in FIG. 1, that stores at least psychological profile 302a and expressions 304a, 304b, 304c, and 304d. Psychological profile 302a may be correlated with expressions 304a and 304d. Upon content 306 being added to a digital environment 308 (e.g., as a new piece of content), psychological profile 302a and expressions 304a and 304d may be determined to comprise an offer 310 that is to be presented to one or more users with psychological profile 302a in digital environment 308.

FIG. 3B may illustrates a client computing platform 104 that presents digital environment 308, the same as in FIG. 3A. Offer 310 may be generated and include at least content 306, expression 304a, and expression 304d. Offer 310 may be presented to the one or more users with psychological profile 302a illustrated in FIG. 3A.

Referring back to FIG. 1, in some implementations, server(s) 102, client computing platform(s) 104, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 132 may be operatively linked via some other communication media.

A given client computing platform 104 may include one or more processors configured to execute computer program components. The computer program components may be configured to enable an expert or user associated with the given client computing platform 104 to interface with system 100 and/or external resources 132, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Server(s) 102 may include electronic storage 134, one or more processors 136, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 134 may comprise non-transitory storage media that electronically stores information. The electronic storage media of electronic storage 134 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from server(s) 102, information received from client computing platform(s) 104, and/or other information that enables server(s) 102 to function as described herein.

Processor(s) 136 may be configured to provide information processing capabilities in server(s) 102. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute components 108, 110, 112, 114, 116, 118, and/or 120, and/or other components. Processor(s) 136 may be configured to execute components 108, 110, 112, 114, 116, 118, and/or 120, and/or other components by software; hardware; firmware; some combination of software, hardware, and/or firmware; and/or other mechanisms for configuring processing capabilities on processor(s) 136. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, and/or 120 are illustrated in FIG. 1 as being implemented within a single processing unit, in implementations in which processor(s) 136 includes multiple processing units, one or more of components 108, 110, 112, 114, 116, 118, and/or 120 may be implemented remotely from the other components. The description of the functionality provided by the different components 108, 110, 112, 114, 116, 118, and/or 120 described below is for illustrative purposes, and is not intended to be limiting, as any of components 108, 110, 112, 114, 116, 118, and/or 120 may provide more or less functionality than is described. For example, one or more of components 108, 110, 112, 114, 116, 118, and/or 120 may be eliminated, and some or all of its functionality may be provided by other ones of components 108, 110, 112, 114, 116, 118, and/or 120. As another example, processor(s) 136 may be configured to execute one or more additional components that may perform some or all of the functionality attributed below to one of components 108, 110, 112, 114, 116, 118, and/or 120.

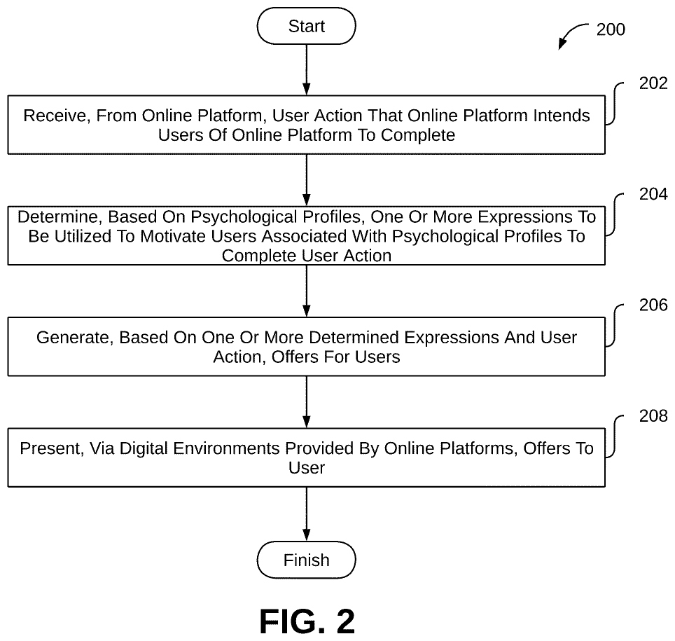

FIG. 2 illustrates a method 200 to identify expressions for offers to be presented to users, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving, from an online platform, a user action that the online platform intends users of the online platform to complete. Operation 202 may be performed by one or more hardware processors configured by machine-readable instructions including a component that is the same as or similar to user action component 108, in accordance with one or more implementations.

An operation 204 may include determining, based on psychological profiles, one or more expressions to be utilized to motivate the users associated with the psychological profiles to complete the user action. The psychological profiles for the users and the expressions may be stored in electronic storage. The psychological profiles may include psychological parameter values to psychological parameters. The expressions may be correlated with one or more psychological parameter values to psychological parameters. The expressions may be units of content that prompt and/or encourage users to complete a specific user action. Operation 204 may be performed by one or more hardware processors configured by machine-readable instructions including a component that is the same as or similar to expression determination component 110, in accordance with one or more implementations.

An operation 206 may include generating, based on the one or more determined expressions and the user action, offers for the users. Operation 206 may be performed by one or more hardware processors configured by machine-readable instructions including a component that is the same as or similar to offer generating component 112, in accordance with one or more implementations.

An operation 208 may include presenting, via digital environments provided by the online platforms, the offers to the user. Operation 208 may be performed by one or more hardware processors configured by machine-readable instructions including a component that is the same as or similar to offer presentation component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to identify expressions for supplementary suggestions to be presented to users, the system comprising:
electronic storage configured to store psychological profiles for users and expressions, wherein the psychological profiles include psychological parameter values to psychological parameters, wherein the expressions are correlated with one or more of the psychological parameter values for the psychological parameters, wherein the expressions are units of content that prompt and/or encourage users to complete a specific user interaction;
one or more processors configured by machine-readable instructions to:
receive, from an online platform, a user interaction with the online platform that the online platform intends users to execute, wherein the user interaction includes creating concept, forming an alliance, preventing formation of other alliances, completing one or more tasks, and/or preventing completion of the one or more tasks by other users;
analyze (i) suggestions and/or recommendations presented to the users via digital environments provided by the online platform and (ii) reactive interactions by the users to the suggestions and/or recommendations, wherein the reactive interactions accept or deny the suggestions and/or recommendations;
determine correlations between one or more of the expressions and psychological parameter values for psychological parameters based on (i) the reactive interactions accepting the suggestions and/or recommendations, (ii) the one or more expressions in the suggestions and/or recommendations, and (iii) the psychological profiles of the users;
store the correlations between the one or more expressions and the psychological parameter values to the psychological parameters;
determine, based on the psychological profiles and the correlations, one or more of the expressions to be utilized to motivate the users associated with the psychological profiles to complete the user interaction;
generate, based on the one or more determined expressions and the user interaction, supplementary suggestions for the users; and
present, via the digital environments provided by the online platform, the supplementary suggestions to the user.

2. (canceled)

3. The system of claim 2, wherein the one or more processors are further configured by the machine-readable instructions to:
monitor effectiveness of the one or more expressions included in the supplementary suggestions presented to the users, wherein the effectiveness indicates whether the one or more expressions cause the users to complete the user interaction; and
update the correlations based on the effectiveness.

4. The system of claim 1, wherein the one or more processors are further configured by the machine-readable instructions to:
receive user preferences for the supplementary suggestions presented to individual ones of the users, wherein the user preferences include specifications for the supplementary suggestions and/or permission for utilization of one or more of the psychological parameters for generation of the supplementary suggestions, wherein the user preferences are associated with the individual users; and
implement the user preferences.

5. The system of claim 4, wherein the specifications include a content type, a game, and/or one or more online platforms.

6. The system of claim 4, wherein the specifications include all online platforms the individual users interact with.

7. The system of claim 4, wherein the one or more processors are further configured by the machine-readable instructions to:
provide, based on the user preferences, benefits to the individual users from the online platforms that are permitted to have supplementary suggestions generated for and presented.

8. The system of claim 7, wherein the benefits include one or more of a monetary amount, a cryptocurrency amount, a stake portion of a company that owns the online platforms, and/or credits usable in the digital environments.

9. The system of claim 8, wherein individual ones of the benefits are determined based on an amount that the online platforms pay for permission to generate and present the supplementary suggestions.

10. The system of claim 1, wherein the expressions include a first expression and a second expression, wherein text for the first expression is different from text for the second expression.

11. A method to identify expressions for supplementary suggestions to be presented to users, the method comprising:
receiving, from an online platform, a user interaction with the online platform that the online platform intends users to execute, wherein the user interaction includes creating concept, forming an alliance, preventing formation of other alliances, completing one or more tasks, and/or preventing completion of the one or more tasks by other users;
analyzing (i) suggestions and/or recommendations presented to the users via digital environments provided by the online platform and (ii) reactive interactions by the users to the suggestions and/or recommendations, wherein the reactive interactions accept or deny the suggestions and/or recommendations;
determining correlations between one or more of the expressions and psychological parameter values for psychological parameters based on (i) the reactive interactions accepting the suggestions and/or recommendations, (ii) the one or more expressions in the suggestions and/or recommendations, and (iii) the psychological profiles of the users;
storing the correlations between the one or more expressions and the psychological parameter values to the psychological parameters;
determining, based on psychological profiles and the correlations, one or more of expressions to be utilized to motivate the users associated with the psychological profiles to complete the user interaction, wherein the psychological profiles for users and the expressions are stored in electronic storage, wherein the psychological profiles include psychological parameter values for psychological parameters, wherein the expressions are correlated with one or more of the psychological parameter values to the psychological parameters, wherein the expressions are units of content that prompt and/or encourage users to complete a specific user interaction;
generating, based on the one or more determined expressions and the user interaction, supplementary suggestions for the users; and
presenting, via the digital environments provided by the online platform, the supplementary suggestions to the user.

12. (canceled)

13. The method of claim 12, further comprising:
monitoring effectiveness of the one or more expressions included in the supplementary suggestions presented to the users, wherein the effectiveness indicates whether the one or more expressions cause the users to complete the user interaction; and
updating the correlations based on the effectiveness.

14. The method of claim 11, further comprising:
receiving user preferences for the supplementary suggestions presented to individual ones of the users, wherein the user preferences include specifications for the supplementary suggestions and/or permission for utilization of one or more of the psychological parameters for generation of the supplementary suggestions, wherein the user preferences are associated with the individual users; and
implementing the user preferences.

15. The method of claim 14, wherein the specifications include a content type, a game, and/or one or more online platforms.

16. The method of claim 14, wherein the specifications include all online platforms the individual users interact with.

17. The method of claim 14, further comprising:
providing, based on the user preferences, benefits to the individual users from the online platforms that are permitted to have supplementary suggestions generated for and presented.

18. The method of claim 17, wherein the benefits include one or more of a monetary amount, a cryptocurrency amount, a stake portion of a company that owns the online platforms, and/or credits usable in the digital environments.

19. The method of claim 18, wherein individual ones of the benefits are determined based on an amount that the online platforms pay for permission to generate and present the supplementary suggestions.

20. The method of claim 11, wherein the expressions include a first expression and a second expression, wherein text for the first expression is different from text for the second expression.
